(19) United States
(12) Patent Application Publication
(10) Pub. No.: US 2021/0283969 A1
(43) Pub. Date: Sep. 16, 2021

(54) Method and System for Achieving Active Suspension using Independently Actuated Wheels

(71) Applicant: Mitsubishi Electric Research Laboratories, Inc., Cambridge, MA (US)

(72) Inventors: Claus Danielson, Boston, MA (US); Di Chen, Ann Arbor, MI (US)

(73) Assignee: Mitsubishi Electric Research Laboratories, Inc., Cambridge, MA (US)

(21) Appl. No.: 16/816,551

(22) Filed: Mar. 12, 2020

(51) Int. Cl. B60G 17/015; B60G 11/18; B60G 17/016; B60G 17/019

(52) U.S. Cl. CPC B60G 17/0157; B60G 11/18; B60G 17/016; B60G 17/01908; B60G 2800/012; B60G 2400/0511; B60G 2400/0512; B60G 2202/422; B60G 2401/14

(57) ABSTRACT

A control system for controlling motions of a vehicle having wheels is provided. The control system includes suspension units configured to support the wheels respectively driven by motors controlled by throttles, a set of sensors configured to detect the motions of the vehicle, wherein the motions are represented by lift, pitch, and roll values of the vehicle, an allocation module configured, in connected with the sensors, to generate and transmit allocated throttle signals to the throttles to minimize the motion by solving an optimization problem related to the motion, and a motor control unit configured to drive each of the motors via the throttles according to the allocated throttle signals.

### FIELD OF THE INVENTION

The present invention relates generally to method for achieving reduced chassis motion using individually actuated wheels, without addition actuator i.e. an active suspension.

### BACKGROUND

An active suspension is a type of vehicle suspension for reducing the motion of the vehicle-chassis due to an uneven road surface. An active suspension uses actuators that reconfigure the suspension in response to the road surface. For instance, an active suspension can use a linear motor to move wheels up or down to reduce the impact of driving over a pot-hole. Active suspensions provide improved ride comfort, but require dedicated actuator hardware that can be potentially expensive.

Anti-lift and anti-squat suspensions are types of vehicle suspension for reducing the motion of the vehicle-chassis due to acceleration and/or deceleration of the vehicle. When a vehicle accelerates, inertia causes the vehicle to pitch resulting in the front-end lifting and the rear-end squatting. For rear-wheel drive vehicles, an anti-squat suspension uses an angled suspension bar to redirect some of the traction force produced rear-wheels into a vertical force that counters the squatting of the rear-end. Hence the name “anti-squat” suspension. For front-wheel drive vehicles, an anti-lift suspension uses an angled suspension bar to counter the natural lifting of the front-end during acceleration. Hence the name “anti-lift” suspension. The anti-lift/squat features of a suspension are a result of the geometry of the suspension design and only require standard (passive) hardware. Suspensions designed for the anti-lift/squat feature are universal in commercial vehicles.

### SUMMARY

Some embodiments of present disclosure are based on recognition that future (e.g. electric) vehicles will employ (e.g. 4) individual motors to independently drive each wheel, rather than a single motor/engine that drives 2 or 4 wheels together. This invention can provide the anti-lift/squat feature of vehicle suspensions and the independently driven wheels to provide the effect of an active suspension, without any additional hardware (other than the individual motors that independently actuator each wheel). This invention is based on the realization that the vertical forces on the vehicle chassis can be manipulated through the anti-lift/squat suspension forces when the wheels are independently driven. For instance, a vehicle driving over a pot-hole will initial pitch forward when the front-wheels enter the pot-hole. This forward pitch can be counter by producing a backward pitch by applying a traction force on the front-wheels and a braking-force on the rear-wheels. When the rear-wheels enter the pot-hole, the opposite forces can be applied. By using a hardware feature (anti-lift/squat) already present in vehicle suspensions and another hardware feature (independently driven wheels) that we predict will be adopted in the future, this invention produces the improvement in ride comfort provided by active suspensions, but without any additional hardware required.

According to embodiments of the present disclosure, a control system for controlling motions of a vehicle having wheels is provided. The control system may include suspension units configured to support the wheels respectively driven by motors controlled by throttles; a set of sensors configured to detect(measure) the motions of the vehicle, wherein the motions are represented by lift, pitch, and roll values of the vehicle; an allocation module configured, in connected with the sensors, to generate/compute and transmit allocated throttle signals to the throttles to minimize the motion by solving an optimization problem related to the motion; and a motor control unit configured to drive each of the motors via the throttles according to the allocated throttle signals.

Further, some embodiments can provide a method for controlling motions of a vehicle having wheels. In this case, suspension units are configured to support the wheels, and the method includes driving the wheels respectively by motors controlled by throttles; measuring the motions of the vehicle using a set of sensors, wherein the motions are represented by lift, pitch, and roll values of the vehicle; computing and transmitting allocated throttle signals to the throttles to minimize the motion by solving an optimization problem related to the motion; and driving each of the motors via the throttles according to the allocated throttle signals.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 shows an illustration for describing the definitions of motions of a vehicle, according to embodiment of this disclosure;

FIG. 2 shows an actuator control system, according to embodiments of the present disclosure;

FIGS. 3A and 3B show the free-body diagram of a front suspension of a vehicle, according to embodiments of the present disclosure;

FIGS. 4A and 4B show the free-body diagram of a rear suspension of a vehicle, according to embodiments of the present disclosure;

FIG. 5 is a schematic for illustrating how traction force allocation produces lift, of a vehicle, according to embodiments of the present disclosure;

FIG. 6 is a schematic for illustrating how traction force allocation produces pitch, of a vehicle, according to embodiments of the present disclosure;

FIG. 7 shows examples of how traction force allocation are performed to avoid chassis motion when driving over a bump on the road, according to embodiments of the present disclosure;

FIG. 8 shows a traction force allocation that result in lift motion without any pitch, roll, or yaw motion, according to embodiments of the present disclosure;

FIG. 9 shows a traction force allocation that result in pitch motion without any lift, roll, or yaw motion, according to embodiments of the present disclosure;

FIG. 10 shows a traction force allocation that result in roll motion without any lift, pitch, or yaw motion, according to embodiments of the present disclosure;

FIG. 11 shows a traction force allocation that result in yaw motion without any lift, roll, or pitch motion, according to embodiments of the present disclosure;

FIG. 12 shows a block diagram of a throttle allocation system, according to embodiments of the present disclosure;

FIG. 13 shows a block diagram for describing a throttle allocation method, according to embodiments of the present disclosure; and

FIGS. 14A and 14B are drawings for describing actuator control methods of a vehicle, according to embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTIONS

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

### Embodiments of the Present Disclosure

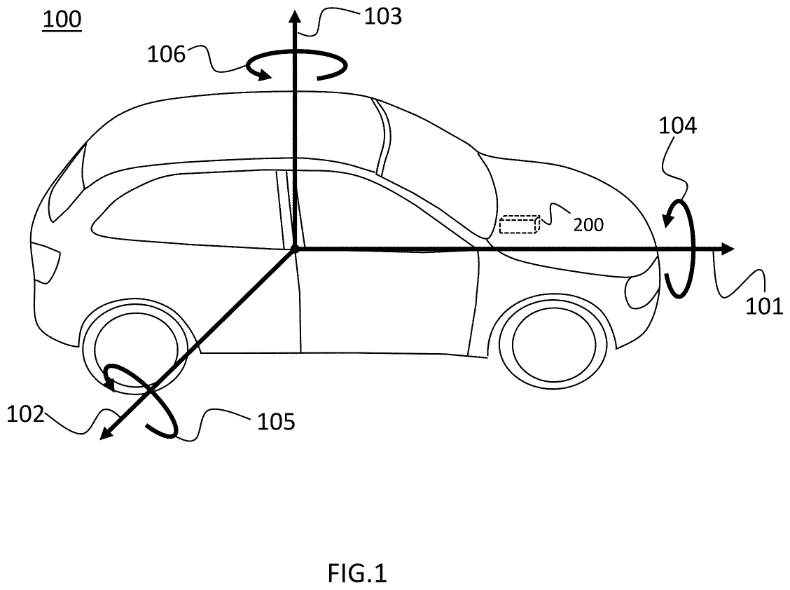

FIG. 1 shows an example of a vehicle 100 (e.g. a car) which is included to define terms used in this disclosure. The vehicle 100 may include (at least) 4 wheels that are attached to the chassis through a suspension system (not shown). In the figure, three axes (x-axis, y-axis and z-axis) are illustrated to describe rotations (102, 103, 104)) of the vehicle 100 about respective axes.

The x-axis 101 of the coordinate frame attached to the vehicle is called the longitudinal direction. Longitudinal motion includes the position, velocity, acceleration, jerk, etc. of the chassis in this direction. Rotation 104 of the chassis about the x-axis 101 is called roll. Roll motion includes the angle, angular velocity, angular acceleration, etc. of the chassis in this direction.

The y-axis 102 of the coordinate frame attached to the vehicle is called the lateral direction. Lateral motion includes the position, velocity, acceleration, jerk, etc. of the chassis in this direction. Rotation 105 of the chassis about the y-axis 102 is called pitch. Pitch motion includes the angle, angular velocity, angular acceleration, etc. of the chassis in this direction.

The z-axis 103 of the coordinate frame attached to the vehicle is called the lift direction. Lift motion includes the position, velocity, acceleration, jerk, etc. of the chassis in this direction. Rotation 106 of the chassis about the z-axis 103 is called yaw. Yaw motion includes the angle, angular velocity, angular acceleration, etc. of the chassis in this direction.

According to embodiments of the present invention, it becomes possible to improve passenger comfort by reducing the motion of the vehicle chassis. For instance, in an autonomous vehicle the passengers may want to read during their commute but unwanted chassis motion could cause motion-sickness.

However, it is important that the invention does not eliminate all chassis motion since the purpose of a vehicle to move the chassis (and its contents) between locations. There are 2 main factors that cause motion in the vehicle chassis; how the vehicle is driven and the quality of the road surface over which the vehicle is driven. The invention reduces chassis motion due to the road roughness without changing how the vehicle is driven. On the contrary, one of the features of the invention is that it maintains the drivability of the vehicle. Drivability means that the vehicle responds to the driver's (human or autonomous) commands in a predictable and repeatable manner. After all, the simplest way to eliminate a bumpy ride is to stop the vehicle, however that would not be a right solution. It is critical that the invention maintains drivability, so that the driver can safely and usefully operate the vehicle.

The driver controls the motion of the vehicle (and its chassis) in the longitudinal and yaw directions. The gas/brake petals control the longitudinal acceleration (and thus velocity and position) and the steering wheel controls the yaw-rate (and thus yaw direction). To improve comfort, the invention allocates traction forces to each of the wheels and sets the steering angle to achieve the driver specified acceleration and yaw-rate while reducing the motion of the chassis in the lift, pitch, and roll directions. Thus, in this disclosure, comfort will be synonymous with lift, pitch, and roll motion of the chassis. According to the present invention, it is possible to reduce lift, pitch, and roll motion of the chassis without sacrificing drivability since this invention is only applicable to vehicles with independently actuated wheels, which provides 3 additional degrees of freedom when maintaining drivability i.e. there are 4 “throttles” instead of 1 for vehicles with independently driven wheels. The invention can also reduce the lateral motion of the vehicle which depends tire slippage to reduce wear on the vehicle tires.

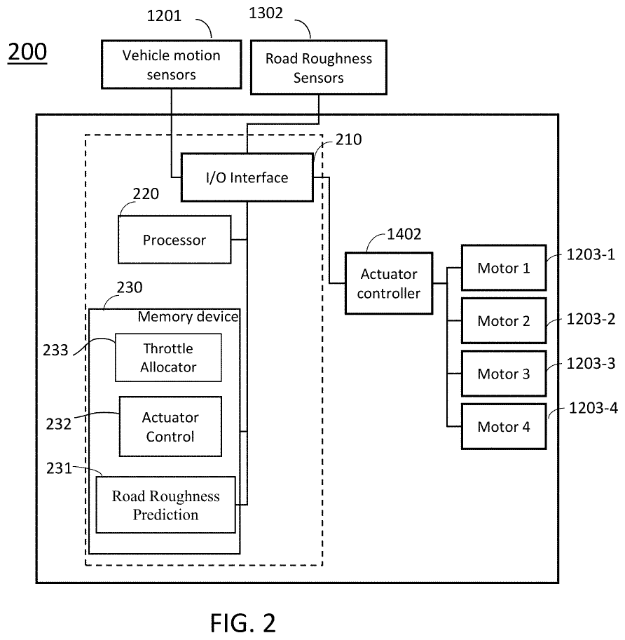

FIG. 2 shows an actuator control system 200 arranged in the vehicle 100, according to embodiments of the present disclosure. The actuator control system 200 may include an input/output interface (I/O) 210 connected to a vehicle sensor(s) 1201 and road roughness sensor(s) 1302, one or more processor 220, a memory device 230 storing computer(processor)-implemented programs including a road roughness prediction program 231, an actuator control program 232 and a throttle allocator program 233.

The interface 210 is configured to form a wired network of the vehicle or a wireless network of the vehicle 100 and perform data communications among the actuator control system 200, the vehicle sensor(s) 1201, the road roughness sensors 1302 and the motors 1-4 of the wheels of the vehicle 100. The processor 220 is configured to perform the road roughness prediction program 231, the actuator control program 232 and the throttle allocator program 233 in response to sensor data from the vehicle sensor(s) 1201 and the road roughness sensors 1302 via the interface 210. Further, the processor 220 is configured to transmit control data to an actuator controller 1402 via the interface 210 while performing the road roughness prediction program 231, the actuator control program 232 and the throttle allocator program 233 in response to signals (data) from the vehicle sensor(s) 1201 and the road roughness sensor 1302. The actuator controller 1402 performs the throttle allocations of the motors 1-4 and the staring control of the vehicle 100 based on the control data with respect to the throttle allocation to each of the motors 1-4 and the steering control from the processor 220.

The memory device 230 can be one or more memory units, which may include one or combination of a random access memory (RAM), a read-only memory (ROM) and a nonvolatile memory and a hard drive. Further, the system 200 may include the actuator controller 1402 that is configured to receive output data (signals) from the processor 220 via the interface 210, and perform the

steering control and the throttle/brake control of each of four motors 1-4 using throttle/brake controllers (torque allocation module) 1203 (1203-1, 1203-2, 1203-3 and 1203-4) of the wheels based on the received output data signals.

According to the present invention, the actuator control system 200 can allocate the traction forces to each of the wheels and sets the steering angle to reduce the chassis motion due to road roughness while maintaining drivability. In one embodiment of the invention, the road roughness is measured by the road roughness sensors 1302 and these measurements are used to compute the traction forces and steering angle of the vehicle 100. In another embodiment of the invention, the road roughness is unmeasured, but the resulting motion of the chassis is measured using the sensors 1201 (vehicle motion sensors 1201) on the vehicle 100 or external sensors (not shown) arranged on/in the vehicle communicating with the actuator control system 200. In this embodiment, the motion sensors 1201 are used to compute the traction forces and steering angle of the vehicle 100. Yet another embodiment of the invention uses measurements of both the road roughness and chassis motion using the vehicle motion sensors 1201 and the road roughness sensors 1302 to compute the traction forces and steering angle that reduce chassis motion and maintain drivability.

According to some embodiments of the invention, it is possible to deal with wheeled vehicles (e.g. cars) that have at least 4 independently actuated wheels arranged to the motors 1-4. In this case, each of the actuated wheels is configured to control both the throttle and braking forces produced by each wheel independently each other.

This invention can also be applied to vehicles with more than 4 independently actuate wheels or groups of independently actuated wheels. Independent actuation can be accomplished for instance by using “hub motors” located in each wheel, however this invention is also applicable when the individual motors are external to the wheel.

Traditional vehicles have two actuators that are used to drive the vehicle: (1) the throttle/brake and (2) the steering angle of the e.g. front tires. These actuators are used to follow a desired acceleration and yaw-rate specified by the driver, which can be human or an autonomous driving system. For a human driver, the desired acceleration and yaw-rate are specified by the position of the gas/brake petal and the steering wheel angle. For an autonomous driver, the desired acceleration and yaw-rate are specified by different methods. Note that traditional vehicles have 2 actuators which are used to achieve 2 driving objectives i.e. throttle/brake and steering wheel track the desired acceleration and yaw-rate.

An embodiments of the invention is based on the realization that vehicles with independently throttled/braked wheels have 3 additional degrees of freedom i.e. 4 throttle/brake and 1 steering angle. It was further realized that these additional degrees of freedom can be used to improve passenger comfort by reducing the lift, pitch, and roll motion of the vehicle chassis.

It should be noted that it is non-obvious how the throttle/brake and steering angle affect the lift, pitch, and roll motion of the vehicle chassis. Some embodiments of the invention are based on the realization that the longitudinal and lateral forces produced by the wheels create vertical forces on the chassis due to the way in which vehicle suspensions are designed. Thus, the relevant features of vehicle suspensions are discussed next.

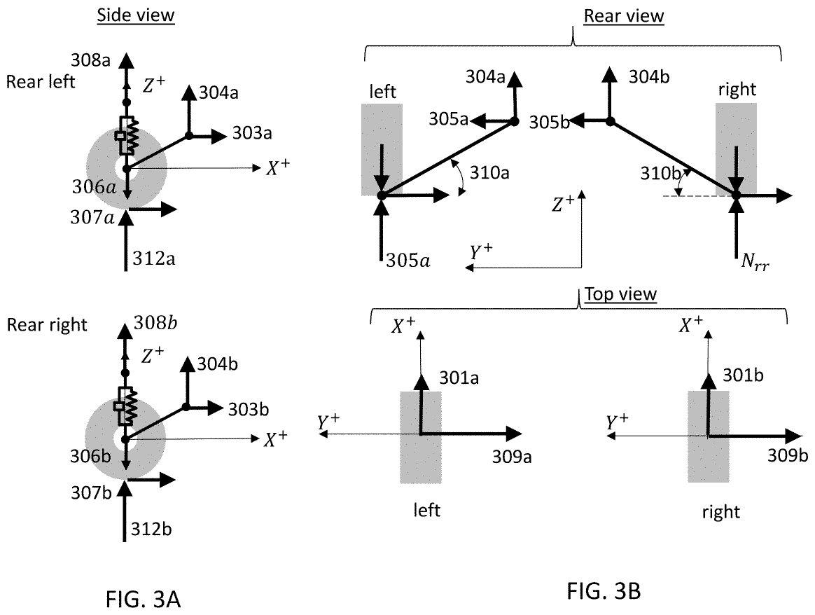

FIGS. 3A and 3B show a trailing arm front suspension. It is well known that other suspension designs are dynamically equivalent to the trailing arm suspension, thus for simplicity we will focus on our discussion to this type of suspension even though some embodiments of the invention are applicable to other suspension designs. The key feature of the trailing arm suspension is the suspension arm which rotates around a pivot. Thus, the wheel cannot move horizontally (i.e. in the longitudinal or lateral direction) without also moving vertically due to the rotation of the suspension arm.

FIGS. 3A and 3B show the forces on the front suspension, illustrating a free-body diagram of the front suspension. The front suspension exerts 4 types of forces on the vehicle chassis (a for left forces and b for right forces):

Longitudinal reaction forces 303a and 303b: The left and right tires must produce driving forces 301a and 301b for the vehicle to accelerate/decelerate. The suspension transmits these driving forces 301a and 301b to the vehicle chassis, producing in the longitudinal forces 303a and 303b.

Lateral reaction forces 304a and 304b: The left and right tires produce sliding forces 309a and 309b, respectively, when the vehicle to turn i.e. the wheels are gripping the road. The suspension transmits these tire-sliding forces 309a and 309b to the chassis, producing the lateral forces 304a and 304b, respectively.

Spring-damper forces 308a and 308b: The deformation of the springs and the movement of the dampers in the suspension produces forces 308a and 308b on the chassis. The deformation/movement of the springs/dampers is caused either by the vehicle chassis moving relative to the road or by the road height “moving” relative to the vehicle i.e. the vehicle is driving over a bump. The spring-damper forces damp the relative chassis-road motion and restore it to the default position i.e. chassis is flat relative to the road.

Vertical reaction forces 304a and 304b: Since the suspension arms are angled, 302a/b and 310a/b, the longitudinal 303a/b and lateral 305a/b forces produce a torque on the suspension arm. In quasi-steady-state, this torque is balanced by the vertical reaction forces 304a/b. Applying a throttle force 302a/b to one of the front wheels results in a negative vertical reaction force 304a/b on the suspension. Since FIG. 3 shows the front suspension, these vertical reaction forces 304a/b are the anti-lift forces that prevent the front end of the vehicle front lifting during acceleration. Some embodiments of the invention are based on the realization that since these vertical reaction forces 304a/b forces depend on the actuated driving forces 303a/b, they can be manipulated to control the lift, pitch, and roll motion of the chassis.

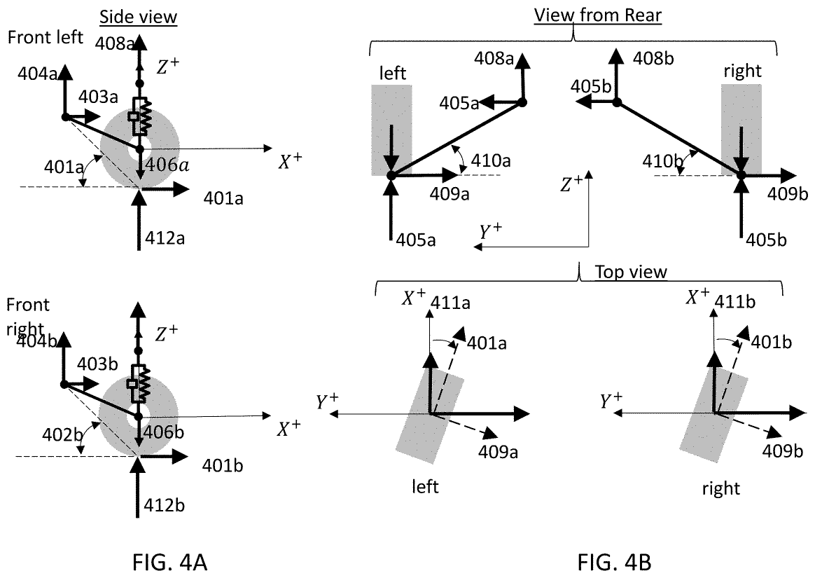

FIGS. 4A and 4B show the free-body diagram of one of the rear suspension assemblies. Similar to the front suspension assembly, we can derive how a throttle force on the rear wheel produces a positive vertical reaction force on the vehicle suspension. This force is called the anti-squat force since it prevents the rear-end of the vehicle from “power squatting” during acceleration.

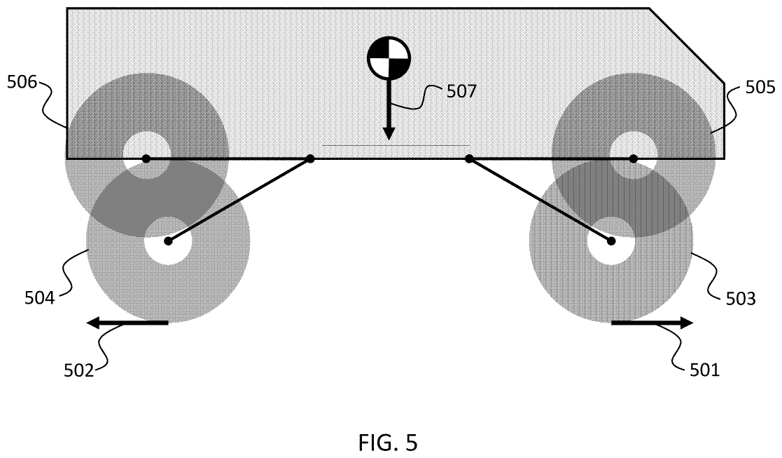

This actuator control system 200 may use these anti-lift and anti-squat forces to manipulate the motion of the vehicle chassis. For instance, FIG. 5 shows how the throttle/brake forces to the front and rear wheels can affect the vehicle lift. The arrows 501 and 502 represent driving forces produced by the front and rear tire respectively. For simplicity, since FIG. 5 only shows the motion of the vehicle in the pitch-plane. Thus, the forces on the front left and right tires in FIG. 5 are the same and likewise for the rear left and right tires. Indeed, for 3D control of the chassis motion it is necessary to applied different forces to the left and right of the vehicle. The traction forces 501 and 502 are in opposition direction i.e. the front wheel is throttling and the rear wheel is braking. This causes the wheels to rotate from the default positions 503 and 504, respectively, into the positions 505 and 506, respectively. This causes the chassis 507 to drop (move in negative lift direction) as shown.

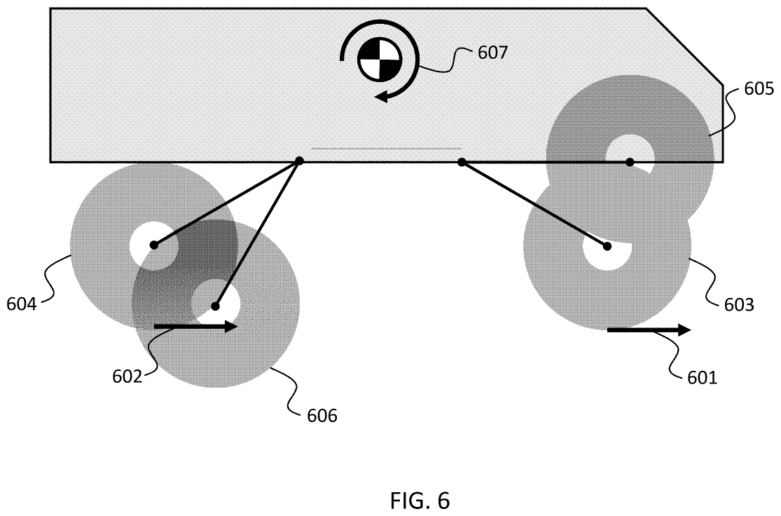

Another example of the lift and pitch motion in the pitch-plane is shown in FIG. 6. In FIG. 6, the same traction 601 and 602 forces are applied to the front and rear wheels. The front wheel rotates forward from the default position 603 to 605 and the rear wheel rotates backwards from the default position 604 to 606. This will cause the chassis 607 to pitch forward as shown. Note that the forward pitching is in opposition to the natural backward pitching that the vehicle will undergo when accelerating. This is called an anti-pitch effect.

An analogous effect occurs in 3 dimensions (i.e. not restricted to the pitch-plane). However, the vehicle dynamics are more complicated since the throttle/braking forces are no longer the only forces acting on the tires. Instead, we must now consider the sliding forces produced by the tires moving in the transverse direction. Nonetheless, a model relating the throttle/brake forces and the steering angle to the lift, pitch, and roll motion of the chassis can be derived. For instances,

$${M}_{s} \ddot{z} = - {M}_{s} g - {\sum }_{i j} {F}_{s j i} + {F}_{z j i} \\ {J}_{X} \ddot{ϕ} = ( {F}_{s f r} - {F}_{s f l} ) \frac{{L}_{f}}{2} + ( {F}_{s r r} - {F}_{s r l} ) \frac{{L}_{r}}{2} + ( {F}_{z f r} - {F}_{z f l} ) \frac{{L}_{f}}{2} + ( {F}_{z r r} - {F}_{z r l} ) \frac{{L}_{r}}{2} - ( {F}_{y f r} + {F}_{v f l} ) ( ( h + z ) - {h}_{f} ) - ( {F}_{y r r} + {F}_{y r l} ) ( ( h + z ) - {h}_{r} ) \\ {J}_{Y} \ddot{θ} = {F}_{s f r} {b}_{f} + {F}_{s f l} {b}_{f} - {F}_{s r r} {b}_{r} - {F}_{s r l} {b}_{r} + ( {F}_{x f r} + {F}_{x f l} ) ( h + z - {h}_{f} ) + ( {F}_{x r r} + {F}_{x r l} ) ( h + z - {h}_{r} ) + ( {F}_{z f r} + {F}_{z f l} ) ( {b}_{f} - {a}_{f} ) - ( {F}_{z r r} + {F}_{z r l} ) ( {b}_{r} - {a}_{r} ) + ( {F}_{z f r} + {F}_{z f l} ) {b}_{f} - ( {F}_{z r r} + {F}_{z r l} ) {b}_{r} \\ {J}_{Z} \ddot{ψ} = ( - {F}_{x f r} + {F}_{x f l} ) \frac{{L}_{f}}{2} + ( - {F}_{x r r} + {F}_{x r l} ) \frac{{L}_{r}}{2} - ( {F}_{y f r} + {F}_{yfl} ) {b}_{f} + ( {F}_{y r r} + {F}_{y r l} ) {b}_{r} \\ {M}_{s} {V}_{x} \dot{β} = - {M}_{s} {V}_{x} \dot{ψ} + {\sum }_{i j} {F}_{xji} sin β - {F}_{y j i} cos β \qquad ( 1 )$$

where the spring-damper forces are given by

Fₛᵣᵢ=−F̅ₛᵢⱼ+KᵣΔzᵢⱼ+CᵣΔżᵢⱼ,

We can use a model relating the throttle/brake forces and the steering angle to the lift, pitch, and roll motion of the chassis for design. However, this model is not required for implementation nor does the model need (1). Indeed, a more accurate physics-based model or a machine-learning model could replace the model (1). The variables of the model are summarized in tables 1 and 2.

TABLE 1

| | |
|---|---|
| β | Slip ratio: ratio of vehicle velocities in longitudinal and lateral |
| | directions |
| Δzᵢⱼ and | Deflects and deflection rates of the front/rear and left/right |
| Δżᵢⱼ, | suspensions |
| Fₓᵢⱼ | Longitudinal reaction forces 303a/b and 403a/b |
| F_{yij} | Lateral reaction forces 309a/b and 409a/b |
| F_{zij} | Vertical reaction forces 304a/b and 404a/b |
| Fₛᵢⱼ | Spring-damper forces 308a/b and 408a/b |

TABLE 2

| | |
|---|---|
| b_{f}, bᵣ | Front/rear wheel base: longitudinal distance from vehicle CG |
| | to front/rear tires |
| L_{f}, Lᵣ | Front/rear track width: lateral distance between left and right |
| | wheels in the front and rear of the vehicle. |
| Mₛ | Mass of the chassis |
| J_{X}, J_{Y}, J_{Z} | Moments of inertia of the chassis about the x, y and z |
| | direction i.e. roll, pitch, and yaw moments of inertia |
| Kᵢⱼ, Cᵢⱼ | Spring-stiffness and damping ratio of each of the suspension |
| | assemblies |

Using the model (1) it is possible to determine allocations of the throttle/braking forces and steering angle that produce 3-dimensional motions analogous to those shown in FIGS. 5 and 6.

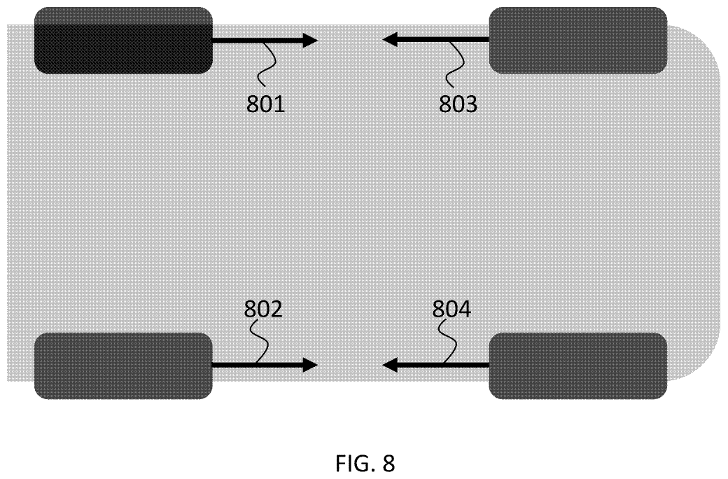

FIG. 8 shows an example of the throttle/braking force allocation that lifts the chassis without any pitch, roll, or yaw motion. Both the left and right rear tires have positive (i.e. throttle) forces 801 and 802 causing the rear-end to lift due to the anti-squat force. The left and right front tires have negative (i.e. brake) forces 803 and 804 causing the front-end of the vehicle to lift since the resulting anti-lift force is negative. This force pattern is similar to FIG. 5. The relative magnitude of the forces 801-804 depends on the numerical values of the parameters of the model.

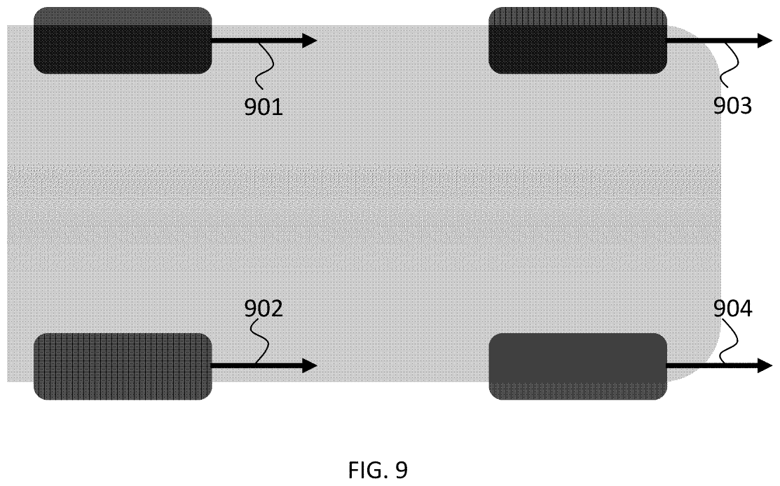

FIG. 9 shows an example of the throttle/braking force allocation that pitches the chassis without any lift, roll, or yaw motion. All the tires have forces 901-904 in the same direction which will cause the vehicle to pitch backward. This force pattern is similar to FIG. 6. The relative magnitude of the forces 901-904 depends on the numerical values of the parameters of the model.

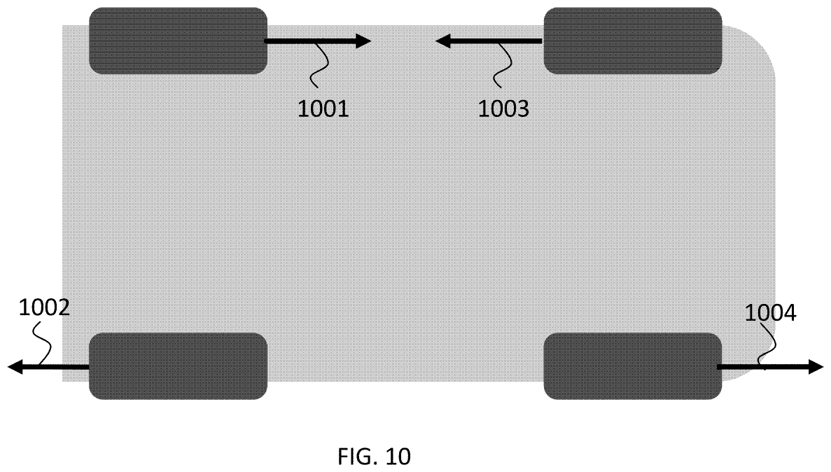

FIG. 10 shows an example of the throttle/braking force allocation that rolls the chassis without any lift, pitch, or yaw motion. The tires on the right-side of the vehicle produce forces 1002 and 1004 with the same pattern as FIG. 5, causing the right-side of the vehicle to drop (i.e. move in negative lift direction). The tires on the left-side of the vehicle produce forces 1001 and 1003 in the opposite pattern as FIG. 5, causing the left-side of the vehicle to lift. The net-result is that the center-of-mass of the vehicle remains stationary while the vehicle rolls. The relative magnitude of the forces 1001-1004 depends on the numerical values of the parameters of the model.

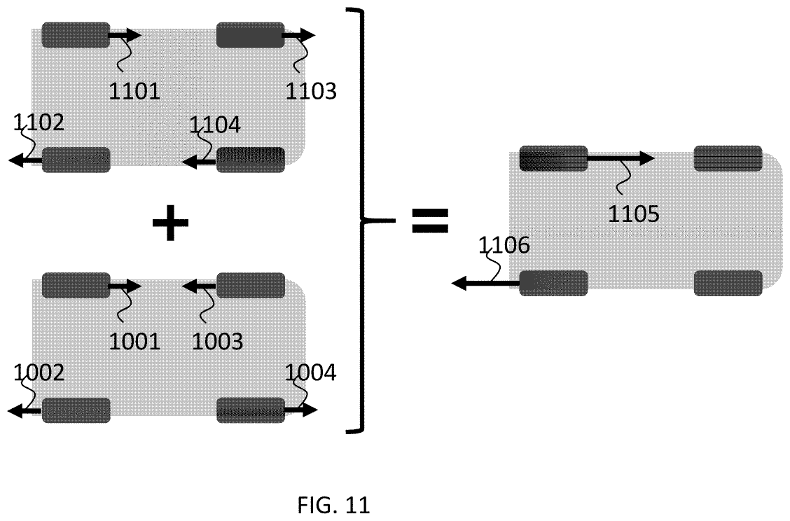

FIG. 11 shows an example of the throttle/braking force allocation that yaws the vehicle without any lift, pitch, or roll, motion. This force allocation is more complicated since yawing/turning the vehicle will create a centripetal force that will cause it to roll. This roll motion must then be compensated. The forces 1101-1104 cause a yaw motion by applied differential forces to the left and right side of the vehicle i.e. the on the left-side the forces 1101 and 1103 are positive while on the right-side the forces 1102 and 1104 are negative. The resulting yaw motion causes the vehicle to roll. By applying the forces 1001-1004 from FIG. 10, this roll motion can be canceled. Adding these forces (1101+1001, 1102+1002, 1103+1003, 1104+1004) resulting in the forces 1105 and 1106. In this allocation, differential driving forces are applied to the left-rear 1105 and right-rear 1106 tires, but no forces are applied to the front tires. This results in the vehicle turning without rolling. In practice, the relative magnitude of the forces 1001-1004 and 1101-1106 depends on the numerical values of the parameters of the model.

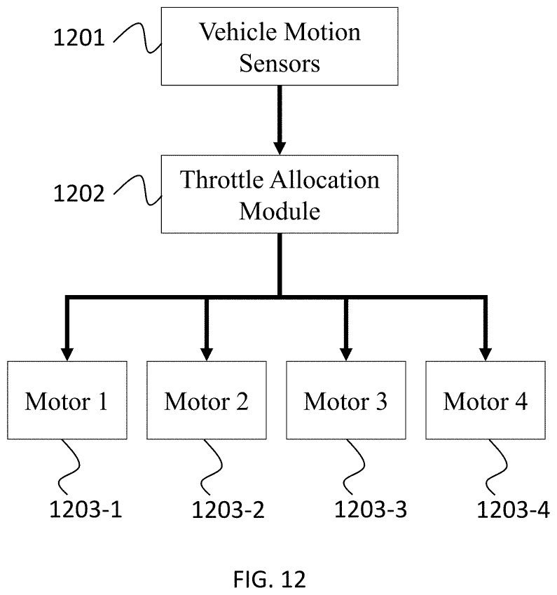

Further, some embodiments of the invention are based on the realization that the relationships between the throttle/braking forces and steering angle and the lift, pitch, roll, and yaw motion of the vehicle shown in FIGS. 8-11 can be used to improve passenger comfort. One embodiment of the invention is shown in FIG. 12. In this embodiment, the system 200 may include 3 modules that work together to improve passenger comfort; a sensor module 1201 that measures (or estimates) the motion of the chassis, a torque allocation module 1203 that computes the desired allocation of driving forces using model (1), and (at least) 4 throttle/brake controllers (torque allocation module) 1203 that implement the desired traction forces for each wheel. The sensor module 1201 can include (but is not limited to) an inertia measurement using, a gravity sensor, accelerometers, a global positioning system, etc. The throttle allocation (torque allocation) module 1202 computes the throttle/brake set-points for the motor/brake controllers based on measurements of the chassis motion and knowledge of how throttle/braking forces effect chassis motion (i.e. model (1)). This module can be e.g. a computer processor, analog circuit, or mechanical linkage. For instance, as an illustrative example, the torque allocation module could consist of a digital computer processor that executes an optimization algorithm that computes the throttle/brake allocation that minimizes chassis motion in real-time. Another illustrative example: the torque allocation module 1202 could consist of an analog circuit that implements the gains of an H state-feedback controller (designed using (1)) which minimizes the integrated RMS response of the chassis motion to the integrated RMS roughness of the road.

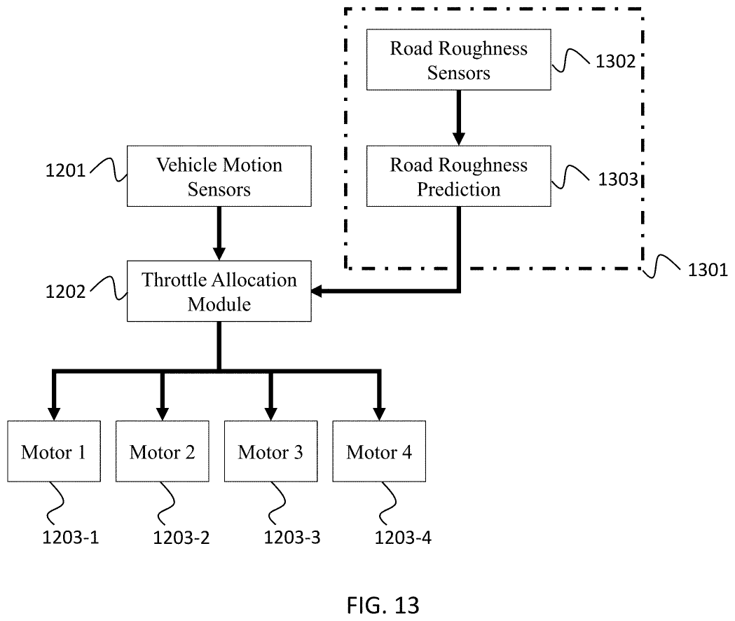

Another embodiment of the invention is shown in FIG. 13. The actuator control system 200 may include an additional module 1301 that predicts the future effects of road roughness on the chassis motion. The module 1301 includes 2 sub-modules; a sensor sub-module 1302 and a predictor sub-module 1303. The sensor sub-module 1302 senses the road ahead of the vehicle. The sub-module 1302 could consist of, for instance, a camera, or radar, or LiDAR (Light Detection and Ranging), or sonar that measures the road surface ahead of the vehicles. The predictor sub-module 1303 predicts when these road bumps will reach each of the tire of the vehicle and the effect they will have on the vehicle. For instance, the predictor sub-module 1303 could consist of a simple model that uses the current velocity of the vehicle and the distance to the bump to determine when a bump will pass beneath each tire. The torque allocation module 1202 can be modified to use this predictive information to further improve passenger comfort. For instance, if the torque allocation module includes a computer processor executing an optimization algorithm then the predicted road roughness can be included in the optimization problem to ameliorate the bump.

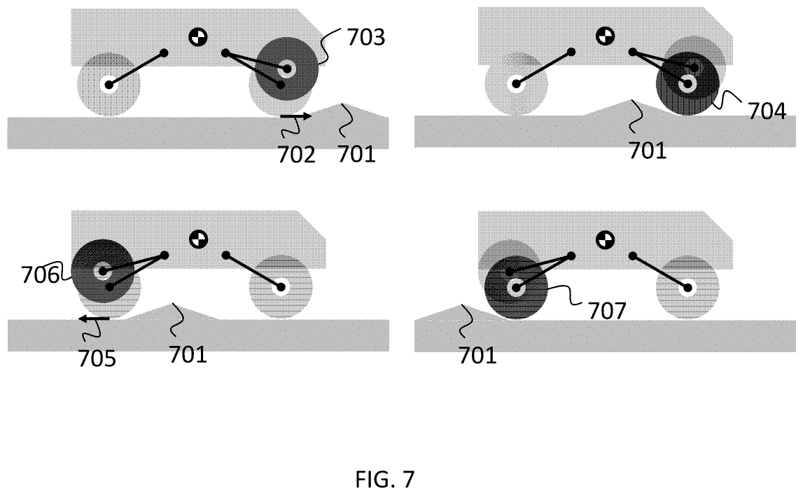

An example of how the actuator control system 200 can use prediction information to ameliorate bumps is shown in FIG. 7. FIG. 7 shows 4 snap-shots of a vehicle encountering a bump 701 on the road. In the first snap-shot, the vehicle is approaching the bump 701. The actuator control system 200 applies throttle 702 to the front-tires to cause them to lift 703 over the bump 701. In the next snap-shot, the actuator control system 200 stops the throttle causing the front wheel to return to ground height 704 after it has passed over the bump 701. In the third snap-shot, the actuator control system 200 applies a braking force 705 to the rear-tires to lift the tires 706 over the bump 701. Finally, the braking force is released allowing the rear-tires to return to their original position 707 after passing over the bump 701.

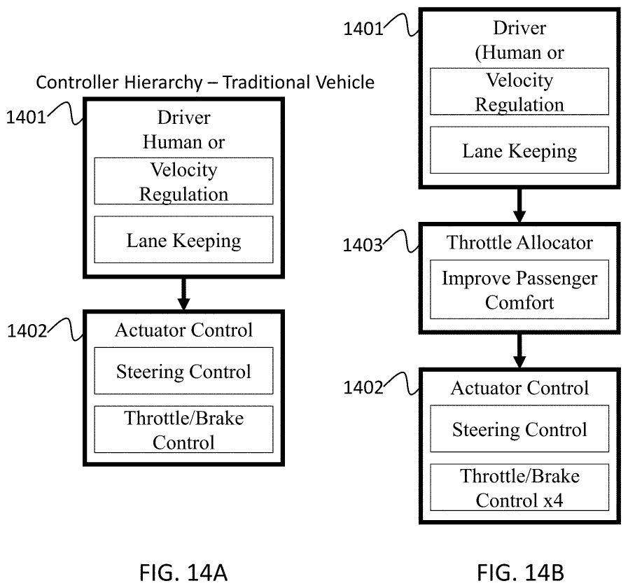

FIG. 14 shows how the actuator control system 200 may be modified by the control/software stack of a vehicle. The current stack may include 2 layers; the driver 1401 (human or autonomous) and the low-level actuators controller 1402. Currently, the driver 1401 (human or autonomous) indicates a desired acceleration/deceleration and turning/yaw-rate using the gas/brake petals and steering wheel and the actuators controllers 1402 implement these desired behaviors. Note that on older vehicles low-level actuator controllers 1402 may be simple feed-through i.e. the driver is directly controlling the throttle via a cable, the brakes via a pneumatic cylinder, and the steering angle via a mechanical linkage. In modern vehicles, the low-level actuator controllers are often more intelligent. However, the actuator control system 200 according to the invention is compatible with any type of low-level actuator controller.

The actuator control system 200 according to the invention may add a new controller layer 1403 between the driver and the actuator controllers. The new controller layer 1403 is the torque allocation module which determines the set-points of each of actuators to both maintain the driving characteristics that the

driver expects (i.e. desired acceleration and yaw/turning are achieved) while improving passenger comfort. According to some embodiments of the present invention, it is possible to provide these addition benefits since it is applied to vehicles with independently actuated throttle/brake for each wheel. Thus, there are 3 additional degrees of freedom for achieve the desired driving profile. The torque allocation module uses the additional degrees of freedom to improve passenger comfort.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Further, the embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Further, use of ordinal terms such as first, second, in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

1. A control system for controlling motions of a vehicle having wheels, comprising:
suspension units configured to support the wheels respectively driven by motors controlled by throttles;
a set of sensors configured to detect the motions of the vehicle, wherein the motions are represented by lift, pitch, and roll values of the vehicle;
an allocation module configured, in connected with the sensors, to generate and transmit allocated throttle signals to the throttles to minimize the motion by solving an optimization problem related to the motion; and
a motor control unit configured to drive each of the motors via the throttles according to the allocated throttle signals.

2. The control system of claim 1, wherein the allocated throttle signals drive the motors to change distances between front side wheels and rear side wheels among the wheels in response to the detected motions.

3. The control system of claim 1, wherein the allocated throttle signals drive the motors to move the wheels on right side closer together and the wheels on left side farther apart to create a roll motion in response to a detected roll motion in the opposite direction.

4. The control system of claim 1, wherein the sensors are cameras.

5. The control system of claim 1, wherein the sensors are angle sensors.

6. The control system of claim 1, wherein the sensors are combination of cameras and angle sensors.

7. The control system of claim 1, wherein the suspension units include torsion bar suspensions.

8. A method for controlling motions of a vehicle having wheels and suspension units configured to support the wheels, comprising:
driving the wheels respectively by motors controlled by throttles;
measuring the motions of the vehicle using a set of sensors, wherein the motions are represented by lift, pitch, and roll values of the vehicle;
computing and transmitting allocated throttle signals to the throttles to minimize the motion by solving an optimization problem related to the motion; and
driving each of the motors via the throttles according to the allocated throttle signals.

9. The method of claim 8, wherein the allocated throttle signals drive the motors to change distances between front side wheels and rear side wheels among the wheels in response to the detected motions.

10. The method of claim 8, wherein the allocated throttle signals drive the motors to move the wheels on right side closer together and the wheels on left side farther apart to create a roll motion in response to a detected roll motion in the opposite direction.

11. The method of claim 8, wherein the sensors are cameras.

12. The method of claim 8, wherein the sensors are angle sensors.

13. The method of claim 8, wherein the sensors are combination of cameras and angle sensors.

14. The method of claim 8, wherein the suspension units include torsion bar suspensions.
